(19) United States
(12) Patent Application Publication
(10) Pub. No.: US 2025/0265251 A1
(43) Pub. Date: Aug. 21, 2025

(54) COMPUTER DATA SYSTEM CURRENT ROW POSITION QUERY LANGUAGE CONSTRUCT AND ARRAY PROCESSING QUERY LANGUAGE CONSTRUCTS

(71) Applicant: Deephaven Data Labs LLC, Plymouth, MN (US)

(72) Inventors: David R. Kent, IV, Colorado Springs, CO (US); Ryan Caudy, New York, NY (US); Charles Wright, Cortlandt Manor, NY (US); Mark Zeldis, Randolph, NJ (US); Radu Teodorescu, New York, NY (US)

(73) Assignee: Deephaven Data Labs LLC, Plymouth, MN (US)

(21) Appl. No.: 19/200,617

(22) Filed: May 6, 2025

Related U.S. Application Data
(63) Continuation of application No. 18/140,786, filed on Apr. 28, 2023, now Pat. No. 12,321,352.
Application No. 18/140,786 is a division of application No. 16/252,944, filed on Jan. 21, 2019, now Pat. No. 11,663,208.
Application No. 16/252,944 is a continuation of application No. 15/154,984, filed on May 14, 2016, now Pat. No. 10,198,465.
(60) Provisional application No. 62/161,813, filed on May 14, 2015.

(51) Int. Cl. G06F 16/2455; G06F 3/0481; G06F 3/0482; G06F 3/0483; G06F 3/04847; G06F 3/0485; G06F 3/04895; G06F 3/06; G06F 8/30; G06F 8/41; G06F 8/60; G06F 11/14; G06F 12/02; G06F 12/084; G06F 12/14; G06F 15/173; G06F 16/11; G06F 16/14; G06F 16/16; G06F 16/215; G06F 16/22; G06F 16/23; G06F 16/242; G06F 16/245; G06F 16/2453; G06F 16/2457; G06F 16/248; G06F 16/25; G06F 16/27; G06F 16/28; G06F 16/901; G06F 16/907; G06F 16/951; G06F 16/9535; G06F 16/9538; G06F 16/955; G06F 16/957; G06F 17/40; G06F 21/00; G06F 21/62; G06F 40/117; G06F 40/134; G06F 40/166; G06F 40/174; G06F 40/177; G06F 40/18; G06F 40/183; G06F 40/216; G06F 40/274; G06Q 40/04; H04L 9/40; H04L 12/18; H04L 51/046; H04L 51/212; H04L 61/5069; H04L 67/00; H04L 67/1001; H04L 67/141; H04L 67/56; H04L 67/566; H04L 67/568; H04L 67/5681; H04L 69/16

(52) U.S. Cl. CPC G06F 16/24561; G06F 3/0481; G06F 3/0482; G06F 3/0483; G06F 3/04847; G06F 3/0485; G06F 3/04895; G06F 3/0605; G06F 3/0656; G06F 3/067; G06F 8/30; G06F 8/41; G06F 8/427; G06F 8/60; G06F 11/1451; G06F 11/1464; G06F 11/1469; G06F 12/0261; G06F 12/084; G06F 12/1483; G06F 15/17331; G06F 16/113; G06F 16/144; G06F 16/162; G06F 16/215; G06F 16/22; G06F 16/221; G06F 16/2228; G06F 16/2237; G06F 16/2246; G06F 16/2255; G06F 16/2264; G06F 16/2272; G06F 16/2282; G06F 16/23; G06F 16/2308; G06F 16/2358; G06F 16/2365; G06F 16/2372; G06F 16/2379; G06F 16/242; G06F 16/2428; G06F 16/245; G06F 16/2453; G06F 16/24534; G06F 16/24535; G06F 16/24537; G06F 16/24539; G06F 16/2455; G06F 16/24553; G06F 16/2456; G06F 16/2457; G06F 16/24575; G06F 16/248; G06F 16/254; G06F 16/27; G06F 16/278; G06F 16/285; G06F 16/9024; G06F 16/907; G06F 16/951; G06F 16/9535; G06F 16/9538; G06F 16/9566; G06F 16/9574; G06F 21/00; G06F 21/6209; G06F 40/117; G06F 40/134; G06F 40/166; G06F 40/174; G06F 40/177; G06F 40/18; G06F 40/183; G06F 40/216; G06F 40/274; H04L 12/18; H04L 51/046; H04L 51/212; H04L 61/5069; H04L 63/101; H04L 63/102; H04L 67/1001; H04L 67/141; H04L 67/34; H04L 67/56; H04L 67/566; H04L 67/568; H04L 69/16; G06F 16/2291; G06F 17/40; G06F 2201/805; G06F 2201/84; G06F 2212/1052; G06F 2212/154; G06F 2212/163; G06F 2212/60; G06Q 40/04; H04L 67/5681

(57) ABSTRACT

Described are methods, systems and computer readable media for providing a current row position query language construct and array processing query language constructs and associated processing.

This application is a divisional of U.S. application Ser. No. 16/252,944, entitled “Computer Data System Current Row Position Query Language Construct and Array Processing Query Language Constructs”, and filed on Jan. 21, 2019, which is a continuation of U.S. application Ser. No. 15/154,984, entitled “Computer Data System Current Row Position Query Language Construct and Array Processing Query Language Constructs”, and filed on May 14, 2016, now patented as U.S. Pat. No. 10,198,465, issued on Feb. 5, 2019, which claims the benefit of U.S. Provisional Application No. 62/161,813, entitled “Computer Data System” and filed on May 14, 2015, which is incorporated herein by reference in its entirety.

Embodiments relate generally to computer data systems, and more particularly, to methods, systems and computer readable media for providing a current row position query language construct and array processing query language constructs and associated processing.

Some conventional computer data systems may maintain data in one or more files that are indexed according to one or more key values. These conventional systems may store data in a relatively static form and that data may be copied to other tables or structures and indexed in those other tables as needed.

Some data systems may include data objects such as tables that include data from columns or other data sources that may be referenced by other different tables or data objects. In such data systems, a need may exist to provide systems and methods for providing and maintaining a mapping between logical table indexes (or other data objects) and data positions within columns or other data sources. The data sources for a given data object may be dynamic in nature and may update periodically. Further, some data systems may not provide an ability within a query language to reference a current location in a data object that may have one or more dynamically updating data sources. Also, some data systems may not provide an ability to transform between column data and array data while taking into account one or more dynamically updating data sources.

Embodiments were conceived in light of the above mentioned needs, problems and/or limitations, among other things.

Some implementations can include a system comprising one or more hardware processors and a computer readable data storage device coupled to the one or more hardware processors, the computer readable data storage device having stored thereon software instructions that, when executed by the one or more hardware processors, cause the one or more hardware processors to perform operations. The operations can include receiving an electronic message associated with a child table, the electronic message including one or more change notifications indicating a change in one or more corresponding parent tables of the child table. The operations can also include updating an index of the child table based on the received one or more change notifications, where the index of the child table includes a mapping between one or more index values in the child table and corresponding positions in one or more data columns mapped by a columns source map of the child table, where the corresponding positions include positions for which data in the one or more data columns is valid for the child table.

The operations can further include, when the child table has one or more dependent tables that depend on data of the child table, generating one or more other electronic messages associated with the one or more dependent tables, the other electronic messages containing change notifications representing updates made to the child table. The operations can also include, when one or more other electronic messages are generated, providing the one or more other electronic messages to corresponding dependent tables.

The change notification can include one or more of an add, a change, a delete or a reindex message associated with data in the child table that depends on data in one of the parent tables. The child table can include a dependency on data of the one or more parent tables.

The change notifications in the other electronic messages can include one or more of an add, a change, a delete or a reindex message associated with data in the child table that depends on data in one of the parent tables. In some implementations, receiving the electronic message can include receiving an electronic message from a listener associated with the one or more parent tables. Providing the one or more other electronic messages to corresponding dependent tables can include causing a listener associated with the one or more dependent tables to be actuated. Some implementations can include another table having a same column source map as the child table and an index different from the index of the child table.

Some implementations can include a method comprising receiving an electronic message associated with a child table, the electronic message including one or more change notifications indicating a change in one or more corresponding parent tables of the child table. The method can also include updating an index of the child table based on the received one or more change notifications, where the index of the child table includes a mapping between one or more index values in the child table and corresponding positions in one or more data columns mapped by a columns source map of the child table, where the corresponding positions include positions for which data in the one or more data columns is valid for the child table.

The method can further include, when the child table has one or more dependent tables that depend on data of the child table, generating one or more other electronic messages associated with the one or more dependent tables, the other electronic messages containing change notifications representing updates made to the child table. The method can also include, when one or more other electronic messages are generated, providing the one or more other electronic messages to corresponding dependent tables.

The change notification can include one or more of an add, a change, a delete or a reindex message associated with data in the child table that depends on data in one of the parent tables. The child table can include a dependency on data of the one or more parent tables.

The change notifications in the other electronic messages can include one or more of an add, a change, a delete or a reindex message associated with data in the child table that depends on data in one of the parent tables. Receiving the electronic message can include receiving an electronic message from a listener associated with the one or more parent tables.

Providing the one or more other electronic messages to corresponding dependent tables can include causing a listener associated with the one or more dependent tables to be actuated. Some implementations can include another table having a same column source map as the child table and an index different from the index of the child table.

Some implementations can include a nontransitory computer readable medium having stored thereon software instructions that, when executed by one or more processors, cause the one or more processors to perform operations. The operations can include receiving an electronic message associated with a child table, the electronic message including one or more change notifications indicating a change in one or more corresponding parent tables of the child table. The operations can also include updating an index of the child table based on the received one or more change notifications, where the index of the child table includes a mapping between one or more index values in the child table and corresponding positions in one or more data columns mapped by a columns source map of the child table, where the corresponding positions include positions for which data in the one or more data columns is valid for the child table.

The operations can further include, when the child table has one or more dependent tables that depend on data of the child table, generating one or more other electronic messages associated with the one or more dependent tables, the other electronic messages containing change notifications representing updates made to the child table. The operations can also include, when one or more other electronic messages are generated, providing the one or more other electronic messages to corresponding dependent tables.

The change notification can include one or more of an add, a change, a delete or a reindex message associated with data in the child table that depends on data in one of the parent tables. The child table can include a dependency on data of the one or more parent tables.

The change notifications in the other electronic messages can include one or more of an add, a change, a delete or a reindex message associated with data in the child table that depends on data in one of the parent tables. Receiving the electronic message can include receiving an electronic message from a listener associated with the one or more parent tables. Some implementations can include another table having a same column source map as the child table and an index different from the index of the child table.

Some implementations can include a system comprising one or more hardware processors, and an electronic computer readable data storage device coupled to the one or more hardware processors, the electronic computer readable data storage device having stored thereon software instructions that, when executed by the one or more hardware processors, cause the one or more hardware processors to perform operations.

The operations can include accessing, at the one or more hardware processors, computer data system query language code stored in the electronic computer readable data storage device, the computer data system query language code including a current row position reference query language construct associated with a data object, and parsing, at the one or more hardware processors, the computer data system query language code into a parsed query language structure. The operations can also include generating, at the one or more hardware processors, computer programming language code based on the parsed query language structure, the computer programming language code including a portion of computer programming language code corresponding to the current row position reference query language construct associated with the data object, and executing, at the one or more hardware processors, the computer programming language code, including the portion of computer programming language code corresponding to the current row position reference query language construct associated with the data object. The operations can further include determining, at the one or more hardware processors, based on execution of the computer programming language code, a return value from the portion of computer programming language code corresponding to the current row position reference query construct associated with the data object, the return value representing a current row position of the data object at a time of execution of the computer programming language code.

The operations can further include when one or more data sources that the data object depends on are updated, subsequently executing, at the one or more hardware processors, the computer programming language code, including the portion of computer programming language code corresponding to the current row position reference query language construct associated with the data object, and determining, at the one or more hardware processors, based on the subsequent execution of the computer programming language code, a new return value from the portion of computer programming language code corresponding to the current row position reference query construct associated with the data object, the return value representing an updated current row position of the data object at a subsequent time of execution of the computer programming language code.

The updated current row position can include an incremented value from a previous current row position. The updated current row position includes a decremented value from a previous current row position. A current row position value of the data object can be updated once data sources providing data for the data object have been updated.

The operations can also include providing an index mapping a current row position to a storage location within a data source providing data for the data object. The computer data system query language code can include code retrieving data from one or more data object positions preceding the current row position in order to compute a time series operation. Some implementations can include a method comprising one or more of the operations described above.

Some implementations can include a system comprising one or more hardware processors, and an electronic computer readable data storage device coupled to the one or more hardware processors, the electronic computer readable data storage device having stored thereon software instructions that, when executed by the one or more hardware processors, cause the one or more hardware processors to perform operations. The operations can include accessing, at the one or more hardware processors, computer data system query language code stored in the electronic computer readable data storage device, the computer data system query language code including a current data storage location reference query language construct associated with a data object, and parsing, at the one or more hardware processors, the computer data system query language code into a parsed query language structure.

The operations can also include generating, at the one or more hardware processors, computer programming language code based on the parsed query language structure, the computer programming language code including a portion of computer programming language code corresponding to the current data storage location reference query language construct associated with the data object, and executing, at the one or more hardware processors, the computer programming language code, including the portion of computer programming language code corresponding to the current data storage location reference query language construct associated with the data object.

The operations can further include determining, at the one or more hardware processors, based on execution of the computer programming language code, a return value from the portion of computer programming language code corresponding to the current data storage location reference query construct associated with the data object, the return value representing a current data storage location of the data object at a time of execution of the computer programming language code.

The operations can further include when one or more data sources that the data object depends on are updated, subsequently executing, at the one or more hardware processors, the computer programming language code, including the portion of computer programming language code corresponding to the current data storage location reference query language construct associated with the data object, and determining, at the one or more hardware processors, based on the subsequent execution of the computer programming language code, a new return value from the portion of computer programming language code corresponding to the current data storage location reference query construct associated with the data object, the return value representing an updated current data storage location of the data object at a subsequent time of execution of the computer programming language code.

The updated current data storage location can include an incremented value from a previous current data storage location. The updated current data storage location can include a decremented value from a previous current data storage location. A current data storage location value of the data object can be updated once data sources providing data for the data object have been updated. The operations can also include providing an index mapping a current data storage location within a data source providing data for the data object to a current row position of the data object.

The computer data system query language code can include code retrieving data from one or more data object data storage locations preceding the current data storage location in order to compute a time series operation. The executing and determining can be performed as part of a real time data system query. Some implementations can include a method comprising one or more of the operations described above.

Some implementations can include a system comprising one or more hardware processors, and an electronic computer readable data storage device coupled to the one or more hardware processors, the electronic computer readable data storage device having stored thereon software instructions that, when executed by the one or more hardware processors, cause the one or more hardware processors to perform operations. The operations can include accessing, at the one or more hardware processors, computer data system query language code stored in the electronic computer readable data storage device, the computer data system query language code including an array processing query language construct including at least a portion of data within a data object as a parameter, and parsing, at the one or more hardware processors, the computer data system query language code into a parsed query language structure.

The operations can also include generating, at the one or more hardware processors, computer programming language code based on the parsed query language structure, the computer programming language code including a portion of computer programming language code corresponding to the array processing query language construct associated with the data object, and executing, at the one or more hardware processors, the computer programming language code, including the portion of computer programming language code corresponding to the array processing query language construct associated with the data object. The operations can further include determining, at the one or more hardware processors, based on execution of the computer programming language code, a return value from the portion of computer programming language code corresponding to the array processing query language construct associated with the data object, the return value including transformed data from the data object.

The array processing query language construct can include a column-to-array query language construct and the transformed data includes array data transformed from column data. The array processing query language construct can include an array-to-column query language construct and the transformed data includes column data transformed from array data.

The operations can further include, when one or more data sources that the data object depends on are updated, subsequently executing, at the one or more hardware processors, the computer programming language code, including the portion of computer programming language code corresponding to the array processing query language construct associated with the data object. The operations can also include determining, at the one or more hardware processors, based on the subsequent execution of the computer programming language code, a new return value from the portion of computer programming language code corresponding to the array processing query construct associated with the data object, the return value including updated transformed data from the data object at a subsequent time of execution of the computer programming language code. The operations can further include performing a vector operation on the array data.

In some implementations, the computer data system query language code can include a vector access query language construct configured to permit access to a vector formed by a column-to-array operation based on the column-to-array query language construct, wherein the access can include one or more of absolute indexing and relative indexing.

In some implementations, the computer data system query language code can include a vector access query language construct configured to permit access to a vector representing an entire column of data values. In some implementations, the access can include one or more of absolute indexing and relative indexing.

### BRIEF DESCRIPTION OF THE DRAWINGS

FIG. 1 is a diagram of an example computer data system showing an example data distribution configuration in accordance with some implementations.

FIG. 2 is a diagram of an example computer data system showing an example administration/process control arrangement in accordance with some implementations.

FIG. 3 is a diagram of an example computing device configured for providing a current row position query language construct and column-array transform query language commands and associated processing in accordance with some implementations.

FIG. 4 is a diagram of an example data system table structure showing an index and a column source map in accordance with some implementations.

FIG. 5 is a diagram of an example data system table structure showing a plurality of indexes and column source maps in accordance with some implementations.

FIG. 6 is a diagram of an example index tree structure in accordance with some implementations.

FIG. 7 is a flowchart of an example position-index mapping process in accordance with some implementations.

FIG. 8 is a diagram of an example relationship between index values, column source logical positions, column source physical locations and index, and physical storage addresses in accordance with some implementations.

FIG. 9 is a diagram of an example table showing a current row position in accordance with some implementations.

FIG. 10 is a flowchart of an example process for processing a current row position query language construct in accordance with some implementations.

FIGS. 11A and 11B are diagrams of example data object results from column/array transform processing in accordance with some implementations.

FIG. 12 is a diagram of an example data object showing a relationship between “i” and “k” and multiple data sources in accordance with some implementations.

FIG. 13 is a diagram of an example data object showing a relationship between “i” and “k” and multiple data sources after one or more rows are filtered out in accordance with some implementations.

FIG. 14 is a diagram of an example data object showing a relationship between “i” and “k” and multiple data sources after one or more rows are inserted in accordance with some implementations.

FIG. 15 is a diagram showing data objects in connection with relative offset processing in accordance with some implementations.

FIG. 16 is a flowchart of an example method for array processing in accordance with some implementations.

### DETAILED DESCRIPTION

Reference may be made herein to the Java programming language, Java classes, Java bytecode and the Java Virtual Machine (JVM) for purposes of illustrating example implementations. It will be appreciated that implementations can include other programming languages (e.g., groovy, Scala, R, Go, etc.), other programming language structures as an alternative to or in addition to Java classes (e.g., other language classes, objects, data structures, program units, code portions, script portions, etc.), other types of bytecode, object code and/or executable code, and/or other virtual machines or hardware implemented machines configured to execute a data system query.

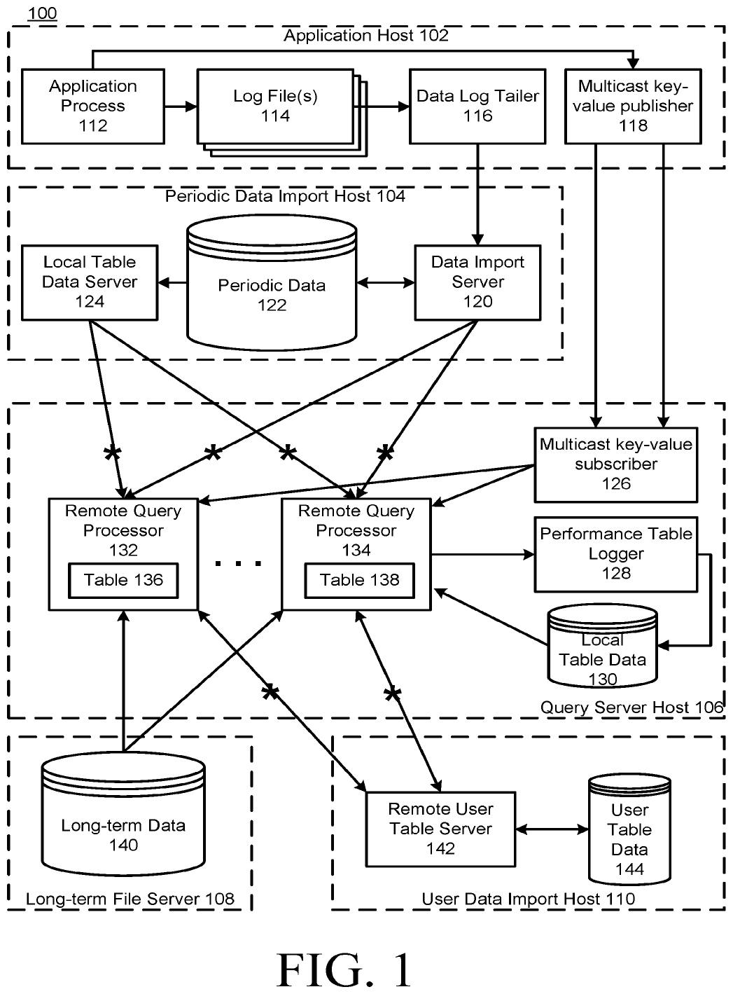

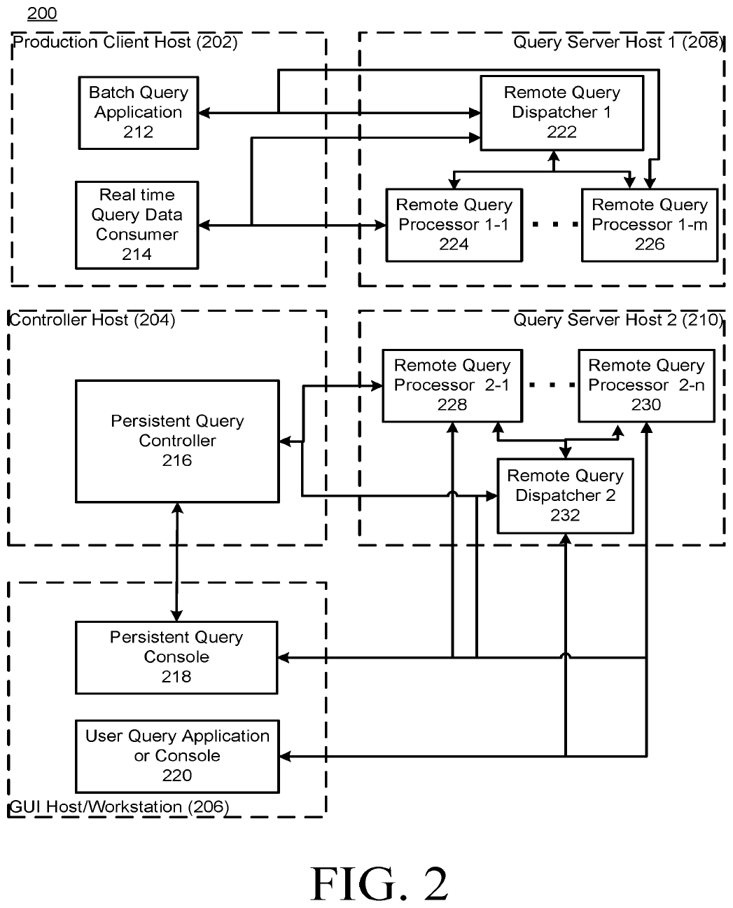

FIG. 1 is a diagram of an example computer data system and network 100 showing an example data distribution configuration in accordance with some implementations. In particular, the system 100 includes an application host 102, a periodic data import host 104, a query server host 106, a long-term file server 108, and a user data import host 110. While tables are used as an example data object in the description below, it will be appreciated that the data system described herein can also process other data objects such as mathematical objects (e.g., a singular value decomposition of values in a given range of one or more rows and columns of a table), TableMap objects, etc. A TableMap object provides the ability to lookup a Table by some key. This key represents a unique value (or unique tuple of values) from the columns aggregated on in a byExternal() statement execution, for example. A TableMap object can be the result of a byExternal() statement executed as part of a query. It will also be appreciated that the configurations shown in FIGS. 1 and 2 are for illustration purposes and in a given implementation each data pool (or data store) may be directly attached or may be managed by a file server.

The application host 102 can include one or more application processes 112, one or more log files 114 (e.g., sequential, row-oriented log files), one or more data log tailers 116 and a multicast key-value publisher 118. The periodic data import host 104 can include a local table data server, direct or remote connection to a periodic table data store 122 (e.g., a column-oriented table data store) and a data import server 120. The query server host 106 can include a multicast key-value subscriber 126, a performance table logger 128, local table data store 130 and one or more remote query processors (132, 134) each accessing one or more respective tables (136, 138). The long-term file server 108 can include a long-term data store 140. The user data import host 110 can include a remote user table server 142 and a user table data store 144. Row-oriented log files and column-oriented table data stores are discussed herein for illustration purposes and are not intended to be limiting. It will be appreciated that log files and/or data stores may be configured in other ways. In general, any data stores discussed herein could be configured in a manner suitable for a contemplated implementation.

In operation, the input data application process 112 can be configured to receive input data from a source (e.g., a securities trading data source), apply schema-specified, generated code to format the logged data as it's being prepared for output to the log file 114 and store the received data in the sequential, row-oriented log file 114 via an optional data logging process. In some implementations, the data logging process can include a daemon, or background process task, that is configured to log raw input data received from the application process 112 to the sequential, row-oriented log files on disk and/or a shared memory queue (e.g., for sending data to the multicast publisher 118). Logging raw input data to log files can additionally serve to provide a backup copy of data that can be used in the event that downstream processing of the input data is halted or interrupted or otherwise becomes unreliable.

A data log tailer 116 can be configured to access the sequential, row-oriented log file(s) 114 to retrieve input data logged by the data logging process. In some implementations, the data log tailer 116 can be configured to perform strict byte reading and transmission (e.g., to the data import server 120). The data import server 120 can be configured to store the input data into one or more corresponding data stores such as the periodic table data store 122 in a column-oriented configuration. The periodic table data store 122 can be used to store data that is being received within a time period (e.g., a minute, an hour, a day, etc.) and which may be later processed and stored in a data store of the long-term file server 108. For example, the periodic table data store 122 can include a plurality of data servers configured to store periodic securities trading data according to one or more characteristics of the data (e.g., a data value such as security symbol, the data source such as a given trading exchange, etc.).

The data import server 120 can be configured to receive and store data into the periodic table data store 122 in such a way as to provide a consistent data presentation to other parts of the system. Providing/ensuring consistent data in this context can include, for example, recording logged data to a disk or memory, ensuring rows presented externally are available for consistent reading (e.g., to help ensure that if the system has part of a record, the system has all of the record without any errors), and preserving the order of records from a given data source. If data is presented to clients, such as a remote query processor (132, 134), then the data may be persisted in some fashion (e.g., written to disk).

The local table data server 124 can be configured to retrieve data stored in the periodic table data store 122 and provide the retrieved data to one or more remote query processors (132, 134) via an optional proxy.

The remote user table server (RUTS) 142 can include a centralized consistent data writer, as well as a data server that provides processors with consistent access to the data that it is responsible for managing. For example, users can provide input to the system by writing table data that is then consumed by query processors.

The remote query processors (132, 134) can use data from the data import server 120, local table data server 124 and/or from the long-term file server 108 to perform queries. The remote query processors (132, 134) can also receive data from the multicast key-value subscriber 126, which receives data from the multicast key-value publisher 118 in the application host 102. The performance table logger 128 can log performance information about each remote query processor and its respective queries into a local table data store 130. Further, the remote query processors can also read data from the RUTS, from local table data written by the performance logger, or from user table data read over NFS, for example.

It will be appreciated that the configuration shown in FIG. 1 is a typical example configuration that may be somewhat idealized for illustration purposes. An actual configuration may include one or more of each server and/or host type. The hosts/servers shown in FIG. 1 (e.g., 102-110, 120, 124 and 142) may each be separate or two or more servers may be combined into one or more combined server systems. Data stores can include local/remote, shared/isolated and/or redundant. Any table data may flow through optional proxies indicated by an asterisk on certain connections to the remote query processors. Also, it will be appreciated that the term “periodic” is being used for illustration purposes and can include, but is not limited to, data that has been received within a given time period (e.g., millisecond, second, minute, hour, day, week, month, year, etc.) and which has not yet been stored to a long-term data store (e.g., 140).

FIG. 2 is a diagram of an example computer data system 200 showing an example administration/process control arrangement in accordance with some implementations. The system 200 includes a production client host 202, a controller host 204, a GUI host or workstation 206, and query server hosts 208 and 210. It will be appreciated that there may be one or more of each of 202-210 in a given implementation.

The production client host 202 can include a batch query application 212 (e.g., a query that is executed from a command line interface or the like) and a real time query data consumer process 214 (e.g., an application that connects to and listens to tables created from the execution of a separate query). The batch query application 212 and the real time query data consumer 214 can connect to a remote query dispatcher 222 and one or more remote query processors (224, 226) within the query server host 1 208.

The controller host 204 can include a persistent query controller 216 configured to connect to a remote query dispatcher 232 and one or more remote query processors 228-230. In some implementations, the persistent query controller 216 can serve as the “primary client” for persistent queries and can request remote query processors from dispatchers, and send instructions to start persistent queries. For example, a user can submit a query to 216, and 216 starts and runs the query every day. In another example, a securities trading strategy could be a persistent query. The persistent query controller can start the trading strategy query every morning before the market opened, for instance. It will be appreciated that 216 can work on times other than days. In some implementations, the controller may require its own clients to request that queries be started, stopped, etc. This can be done manually, or by scheduled (e.g., cron) jobs. Some implementations can include “advanced scheduling” (e.g., auto-start/stop/restart, time-based repeat, etc.) within the controller.

The GUI/host workstation can include a user console 218 and a user query application 220. The user console 218 can be configured to connect to the persistent query controller 216. The user query application 220 can be configured to connect to one or more remote query dispatchers (e.g., 232) and one or more remote query processors (228, 230).

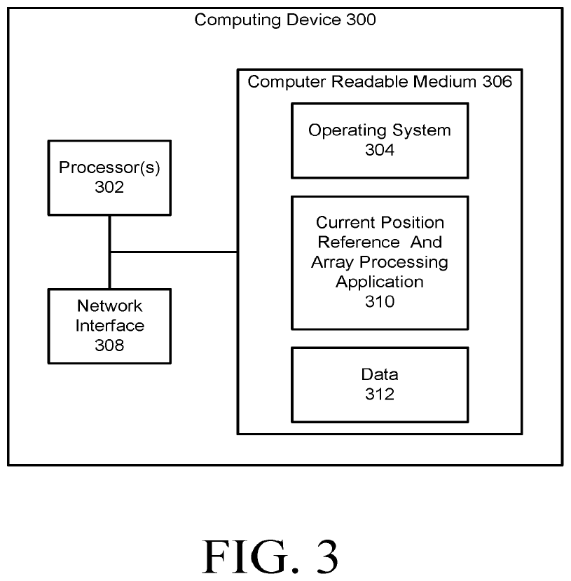

FIG. 3 is a diagram of an example computing device 300 in accordance with at least one implementation. The computing device 300 includes one or more processors 302, operating system 304, computer readable medium 306 and network interface 308. The memory 306 can include a current row position query language construct and column-array transform query language command code parsing, generating and executing application 310 and a data section 312 (e.g., for storing query language code, parsed query language structures, computer programming language code, executable code, etc.).

In operation, the processor 302 may execute the application 310 stored in the memory 306. The application 310 can include software instructions that, when executed by the processor, cause the processor to perform operations for providing a current row position query language construct and column-array transform query language commands and associated processing in accordance with the present disclosure (e.g., performing one or more of 702-706, 1202-1214, and/or 1602-1614 described below).

The application program 310 can operate in conjunction with the data section 312 and the operating system 304.

In general, a data object, such as a table, can include an index and a column source map. The index can include information mapping logical data object index values to corresponding valid data positions within the column source(s) that make up the data object. The column source map can include mapping information mapping column names to associated column sources. Data objects such as tables typically reference column source data in columns sources indicated by the column source map. For example, column source data could reference a large column split over many files in many locations on disk, or it could refer to a small, in-RAM array. Primary tables, (i.e., tables that are sources of data) can have the ability to create change notifications (e.g., add, modify, delete or reindex (AMDR) messages) when their underlying data changes. Non-primary tables may generate notifications (e.g. AMDR messages) in response to their inputs (primary or non-primary) changing.

A plurality of tables can point at a given column source. A given table may have no more claim to “ownership” of a commonly referenced column source than another table that also references that same commonly referenced column source. The “ownership” of the column source may be handled in some implementations via Java references and garbage collection.

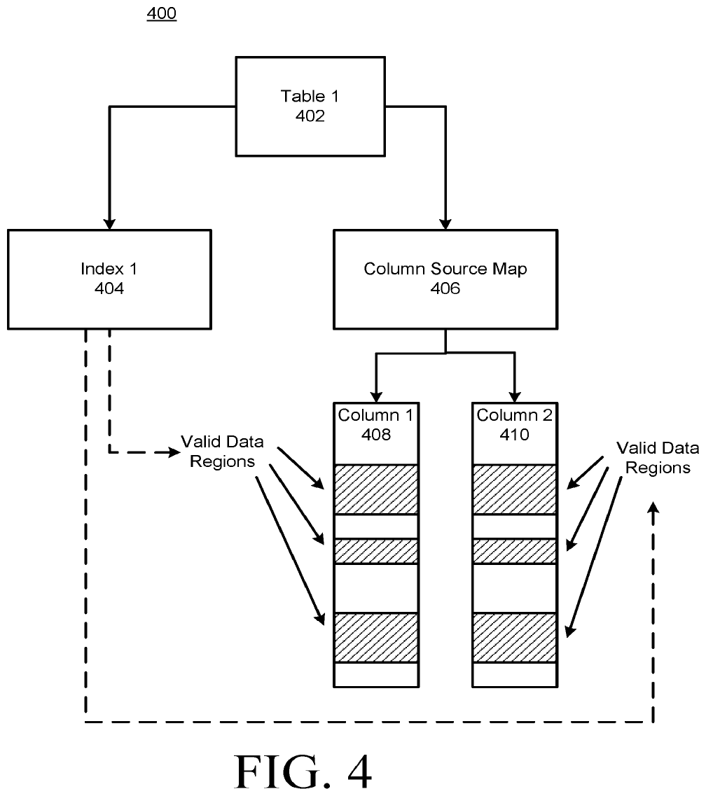

FIG. 4 is a diagram of an example data system table structure 400 showing a table 402 having an index 404 and a column source map 406. The column source map 406 provides a mapping between column names of the table 402 and one or more column sources (408, 410). The index 404 provides a mapping between index values of the table 402 and corresponding valid data regions of the one or more column sources (408, 410). It will be appreciated that a column source may be assembled from data in multiple physical locations (e.g., a first section from location 1 and second section from location 2, etc.).

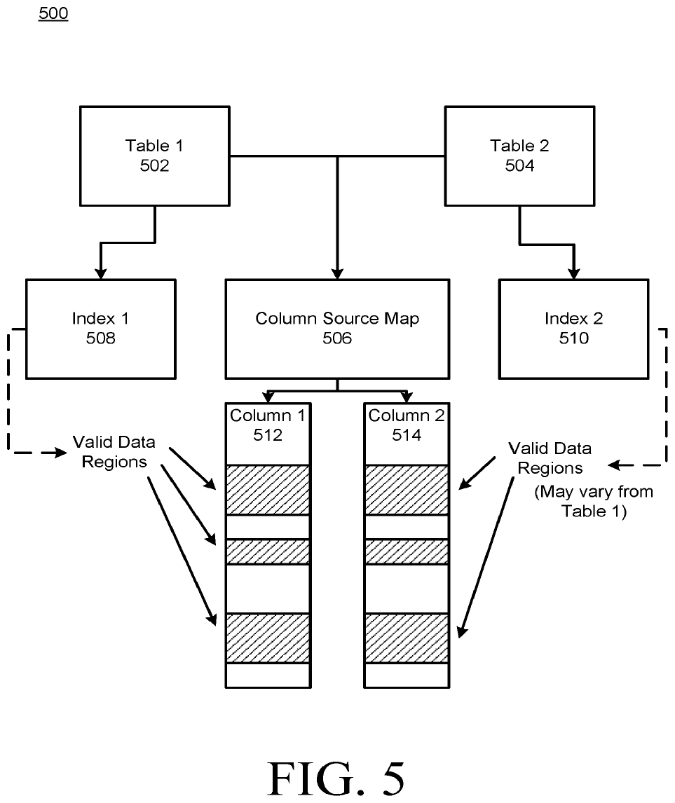

FIG. 5 is a diagram of an example data system table structure 500 having a first table 502 and a second table 504. In this example, the two tables (502, 504) share a common column source map 506 and each table (502, 504) has a respective index (508, 510). Each index (508, 510) provides a mapping for its corresponding table index values and valid data regions in one or more column sources (512, 514). The indexes (508, 510) may be the same or different depending on the tables (e.g., 502, 504) that the indexes correspond to. If the tables are the same, then the indexes may be the same. If the tables are different, then the indexes may be different, even when the two tables use a common column source map. Further, if table 2 (504) is derived from table 1 (502), the table 2 valid data region(s) will be a subset of the table 1 valid data region region(s).

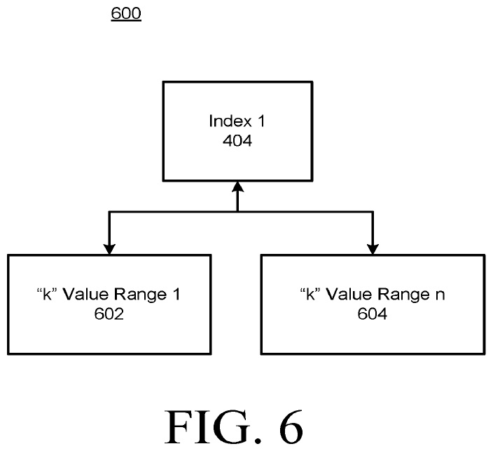

FIG. 6 is a diagram of an example index tree structure 600 having a first range 602 of valid data positions (or “k” values) corresponding to table index values (or “i” values) and a second range 604 of valid data positions. The tree structure 600 shown in FIG. 6 is an example of a possible implementation for an index. It will be appreciated that other data structures can be used to store the index. The index may be in ascending order, where the order of the index can define how the table should be iterated.

In some implementations, the address space for disk-backed tables is a distinct concept from the tree structure used for index ranges in memory. Disk-backed tables can use ranges of indexes that can be thought of as being conceptually analogous to a multi-level page table used by virtual memory systems.

In some implementations, the index structure can include a list of non-negative 64-bit values. When two or more consecutive values are stored in the list, an optimization can be made that includes storing the beginning and end of the range. The end of the range is stored as the negation of the end. For example, an index of {0, 1, 2, 4, 6, 7} can be stored as {0, −2, 4, 6, −7}, which can reduce the memory footprint when an index has consecutive values, which may be common for many tables (e.g., the physical addressing described below).

As mentioned above, in some implementations the index is physically stored as a tree data structure. The index tree can include leaf nodes, which can contain a given number of “slots” (e.g., 64). Each node can contain a size and a count. The size can include the number of logical items, the count can include the number of filled slots. The slots are simply long values in the representation described above. Leaf nodes may be compressed or “packed” by storing an array of shorts or ints instead of longs with an offset/mask that is applied to the data items. This is useful, for example, when ranges of values within a single partition may be close together and storing those adjacent values as a short will reduce memory usage.

An interior node has pointers to a left and a right child, as well as the node's size, min, and max. This node configuration can permit traversal of the index to a particular position or key value efficiently.

Also, some implementations can provide for efficient index serialization when sending the indexes over the network or storing persistently. Each value can be stored as an offset from the last value (with negative numbers just a negated offset, to represent ranges). Further, the smallest data type required (e.g., bytes, shorts, ints or longs) can be used for the offsets, which can reduce the complexity/size of the index representation transmitted over a network. The example index of {0,1, 2, 4, 6, 7} can be logically represented as {0, −2, 4, 6, −7}, and converted to offsets of {0, −2, 2, 2, −1}. With small numbers, the offsets/sizes may not provide as much benefit, however, when representing more complex address spaces, the offset/size optimizations can provide a more significant benefit.

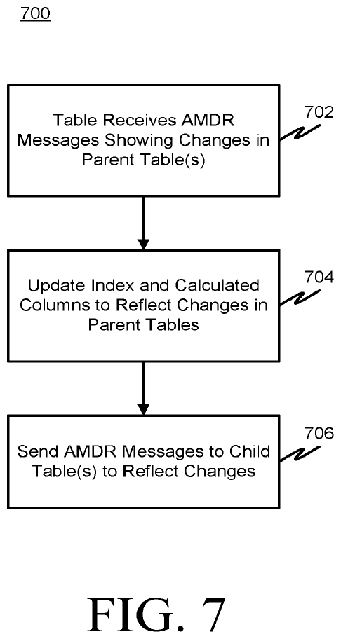

FIG. 7 is a flowchart of an example position-index mapping process 700 in accordance with some implementations. Processing begins at 702, where a table (e.g., a child table such as 402, 502, 504 etc.) receives an electronic message containing one or more change notifications providing information about corresponding changes in one or more parent tables of the child table. Each change notification can include one or more of an add message, a modify message, a delete message, and a reindex message (or AMDR message). Each AMDR message can include one or more index values and, optionally, one or more data values. The change notifications may be received via one or more listeners associated with the child table and a corresponding parent table. Processing continues to 704.

At 704, the child table index and calculated columns are updated based on the received change notifications to reflect changes in one or more parent tables that are relevant to data of those tables for which the child table has a dependency. Processing continues to 706.

At 706, the child table sends electronic change notifications (e.g., AMDR messages) to any dependent tables (i.e., child tables of the child table) to reflect the changes made to the child table that may be relevant to any dependent tables. The change notifications may be provided to dependent tables via actuation of a listener for a respective dependent table.

It will be appreciated that 702-706 may be repeated. For example, 702-706 may be repeated during each update cycle of a logical system clock in which one or more change notification messages for the child table are available.

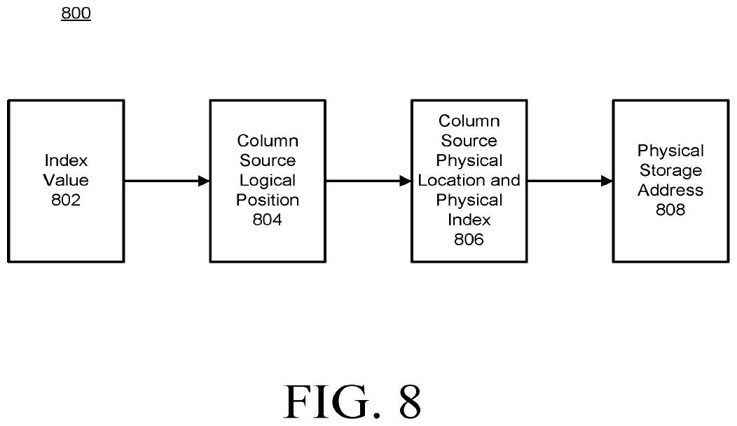

FIG. 8 is a diagram of an example relationship 800 between index values 802, column source logical positions 804, column source physical locations and indexes 806, and physical storage addresses 808.

It will be appreciated that each of the stages shown in FIG. 8 can represent an address translation. For example, the index 802 provides a list of valid addresses, and a translation from a position, to those valid addresses.

A column source may be unaware of row positions, but may be aware of the logical address space of that column source. For example, in an ArrayBackedColumnSource, the address space could be a simple range from 0 . . . n-1 that matches the backing array.

Disk backed column sources typically may be divided into regions, with each region representing an internal data partition. For example, the column source could identify a partition (e.g., a set of column files) using the high-order bits of the logical address, and a row within that partition using the low-order bits of the logical address.

As these addresses may need translation, some implementations can include a RedirectedColumnSource, which can include an inner address space (e.g., matching some other wrapped column source) and an outer address space (e.g., matching the address space for the index that is referencing it). Two examples of RedirectedColumnSources include, but are not limited to: (1) the result table from a sort() operation, and (2) when performing an update() operation, the result table reuses the original column sources and index, but creates an ArrayBackedColumnSource to hold the results of the update operation, with a RedirectionIndex to map the potentially sparse outer index to the potentially dense inner address space.

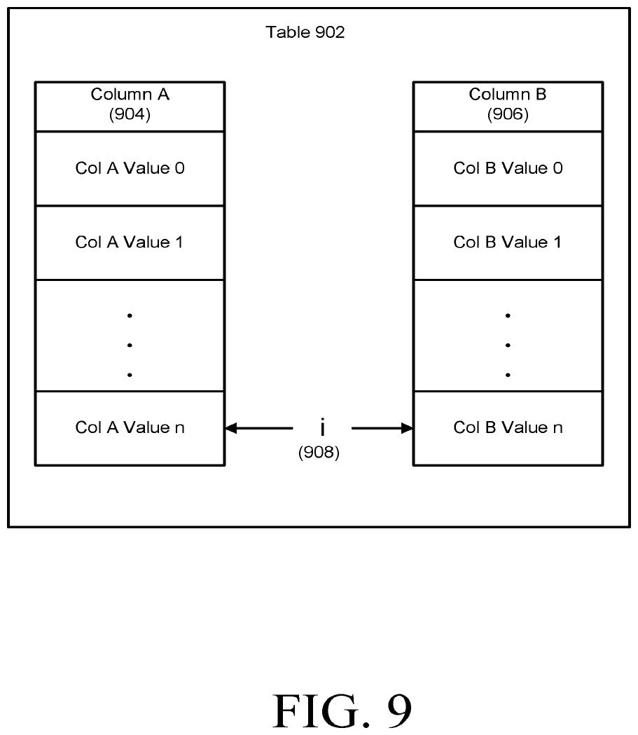

FIG. 9 is a diagram of an example table 902 having two columns (904 and 906) showing a current row position 908 in accordance with some implementations. It will be appreciated that “i” is meaningful within one table and may not have meaning between two different tables. The query language construct “i” can be thought of as the row number for the current row position when evaluating a formula. “k” indicates a storage location of the data (e.g., a column store location). During a data object update cycle, “i” values may get updated along with their associated data object portion (e.g., table row). Thus, for dynamic tables (e.g., tables that have one or more data sources that dynamically update), the “i” and “k” values may be dynamic and may be updated along with the table.

Some implementations can include “i” and “k” as constructs of a data system query language. When query language code containing “i” or “k” constructs is parsed and code is generated from the parsed structure, “i” and “k” get mapped to generated functions in programming language code that, in turn, gets compiled. Once the compiled code is executed, the mapped functions return the proper values for “i” and “k.”

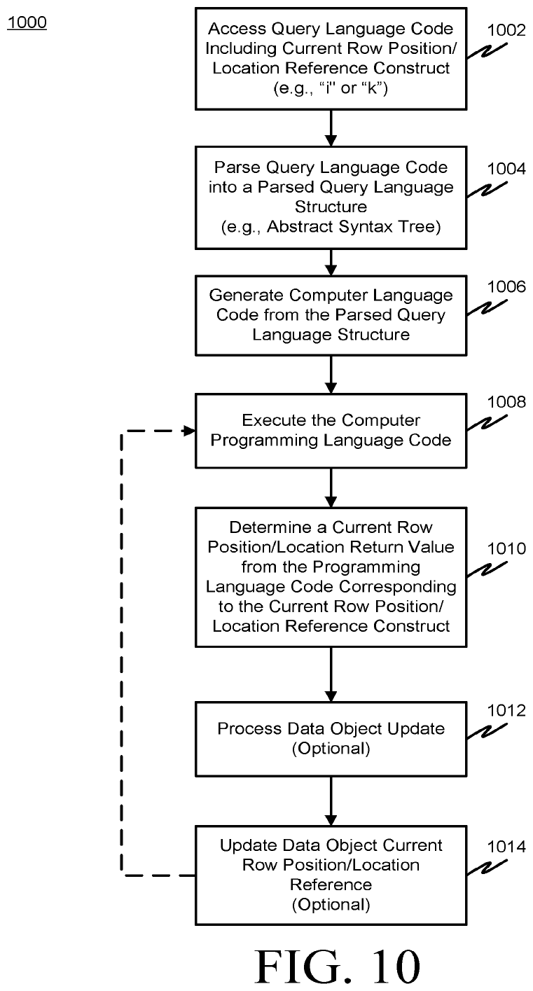

FIG. 10 is a flowchart of an example process 1000 for processing a current row position query language construct in accordance with some implementations. Processing begins at 1002, where query language code is accessed. The query language code including a current row position (e.g., “i”) or current data location (e.g., “k”) construct. Processing continues to 1004.

At 1004, the data system query language code is parsed into a parsed query language structure (e.g., a syntax tree, an abstract syntax tree, or the like). Processing continues to 1006.

At 1006, computer programming language code is generated from the parsed query language structure. Computer programming language functions are generated and mapped to usages of “i” and “k” from the query language code. The generated computer programming language code can be compiled. Processing continues to 1008.

At 1008, the compiled computer programming language code is executed on one or more hardware processors. Processing continues to 1010.

At 1010, when the executable code corresponding to the current row

position/location construct is executed, the programming language code determines a current row position/location and returns a current row position reference value or a current location reference value depending on whether the code for an “i” reference or a “k” reference is being executed. Processing continues to 1012.

At 1012, an update for the data object is optionally processed. An update can include one or more add, modify, delete or reindex messages being processed for the data object. Processing continues to 1014.

At 1014, the current row position (or “i”) and current location (or “k”) for a data object may be updated based on changes to one or more rows within columns comprising the data object. Processing returns to 1208, where the programming language code continues to execute.

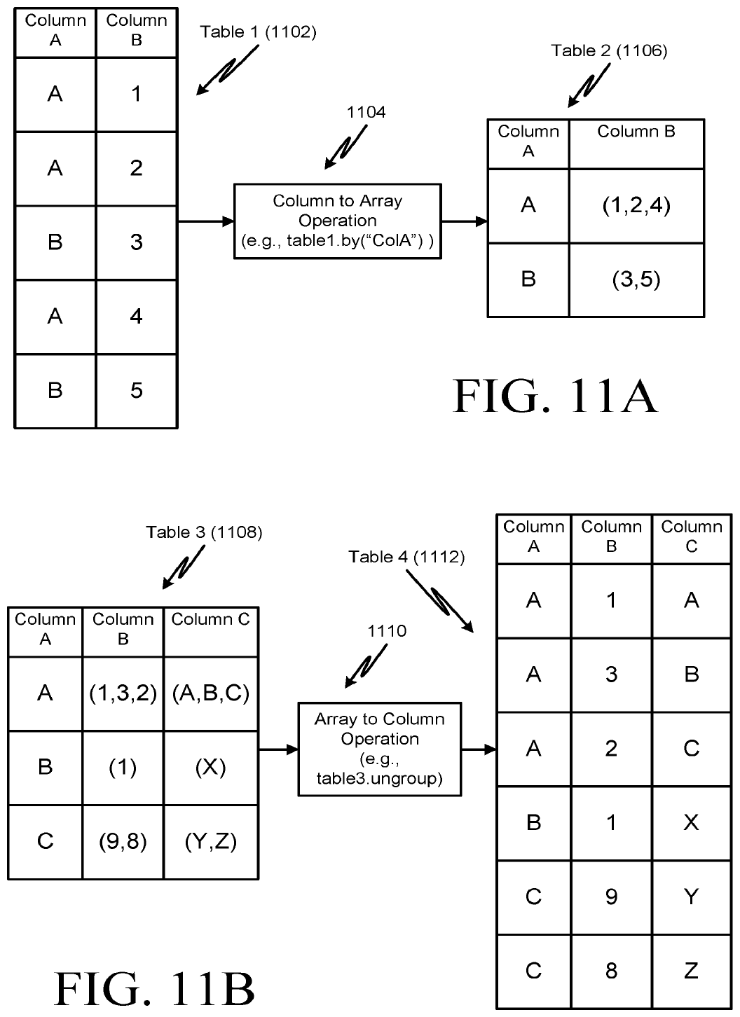

FIGS. 11A and 11B are diagrams of example data object results from

column/array transform processing in accordance with some implementations. In FIG. 11A, Table 1 (1102) servers as an input data object to a column-to-array operation 1104, which can be implemented, for example, as a construct in computer data system query language code such as table1.by(“ColA”). It will be appreciated that a different construct, syntax, etc. could be used.

The query language construct for the column-to-array operation can get parsed into a parsed query language structure, which can be used to generate computer programming language code that is compiled and executed. When executed, the compiled computer programming language code corresponding to the example column-to-array operation produces Table 2 1106. In the example shown in FIG. 11A, the “by” operation transforms column data in Table 1 (1102) Column B into array data in Column B of Table 2, where the array data is grouped according to the values of Column A in Table 1 in this example. Some implementations can include a query language construct to access the array or vector formed by the column-to-array operation using absolute or relative indexing into one or more of the arrays formed by the column-to-array operation.

FIG. 11B shows an example diagram of an array-to-column operation. In particular, Table 3 (1108) is used as input to an array-to-column operation 1110. The array-to-column operation 1110 can include a computer data system query language construct such as table3.ungroup. The ungroup operation is an example of a an array-to-column operation that takes array data as shown in columns B and C of Table 3 1108 and transforms the array data into column data as shown in columns B and C of Table 4 (1112). The column data can be organized by Column A values.

Similar to the processing discussed above regarding FIG. 11A, the query language construct for the array-to-column operation 1110 can get parsed into a parsed query language structure, which can be used to generate computer programming language code that is compiled and executed. When executed, the compiled computer programming language code corresponding to the example array-to-column operation 1110 produces Table 4 1112. In the example shown in FIG. 11B, the “ungroup” operation transforms array data in Table 3 (1108) Columns B and C into array data in Columns B and C of Table 4, where the column data is grouped according to the values of Column A in Table 4.

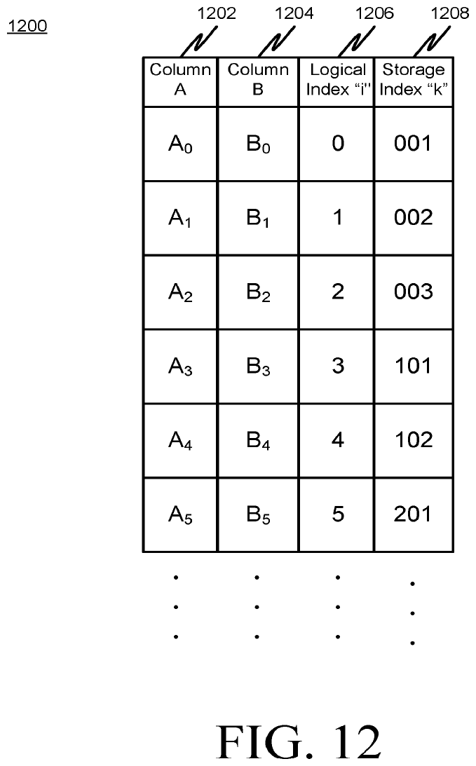

FIG. 12 is a diagram of an example data object 1200 showing a relationship between “i” represented by 1206 and “k” represented by 1208 and multiple data columns (1202, 1204). In particular, a user of the computer data system may be presented with (and view) a table such as columns 1202 and 1204 shown in FIG. 12 as one “clean” table. However, in some instances, the single “clean” table presented to the user is actually composed of data from one or more data sources. The “i” and “k” columns (1206 and 1208) are not columns of the table per se, but rather may reside in or be derived from an index structure for the table. The “i” and “k” columns are shown together with the table data in FIG. 12 for illustration purposes.

In operation, the “i” values correspond to logical row positions in the table (e.g., a reference to a row position of the table, such as i=5 in table 1200 of FIG. 12) and the “k” values contain information for looking up data quickly from the sources that comprise the construction of the table. When a user uses “i” in computer data system query language code, the system maps “i” to “k” in order to access the data.

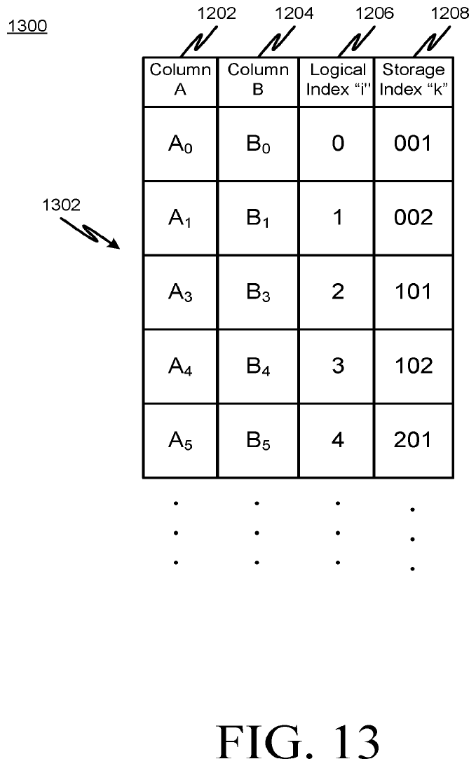

FIG. 13 shows a table 1300 (which is based on table 1200 shown in FIG. 12) in which a row has been filtered out of the table as a result of a query operation. The row containing A2 and B2 has been filtered out from the location referenced by 1302. The logical indexes (“i” values) for the subsequent rows has been adjusted (in this case decremented) to reflect the filtering out of the row. It should also be noted that while the logical index values in rows subsequent to the filtered row have been adjusted, the storage locations (“k” values) have remained the same for the subsequent rows because the storage locations did not change or need to be adjusted.

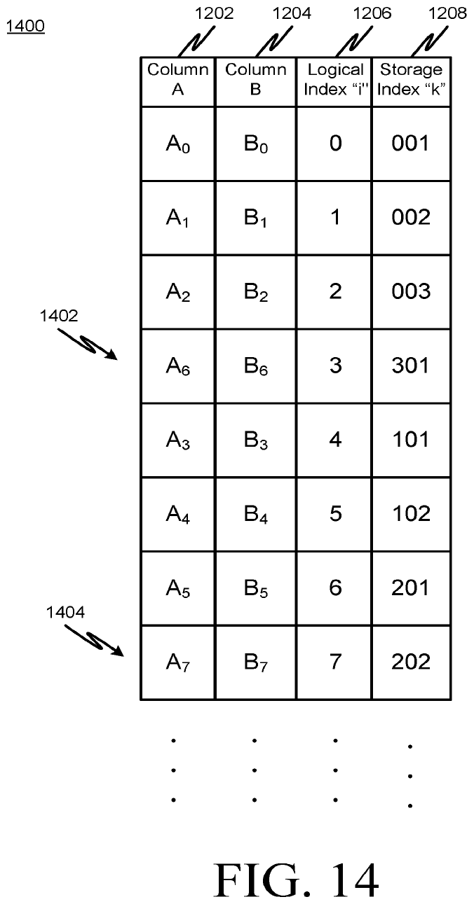

FIG. 14 shows a table 1400 (which is based on table 1200 shown in FIG. 12) in which two rows (1402 and 1404) have been added. As can be seen in table 1400, the logical values of the rows subsequent to the inserted row 1402 have been adjusted (in this case incremented) to reflect the addition of the row in the location at 1402 (which may have been added in that location to maintain strict ordering, for example). The storage locations of the rows previously present did not change. The storage locations of the new rows reflect the locations associated with those rows and may include locations from the same or different sources as the other rows in the table 1400.

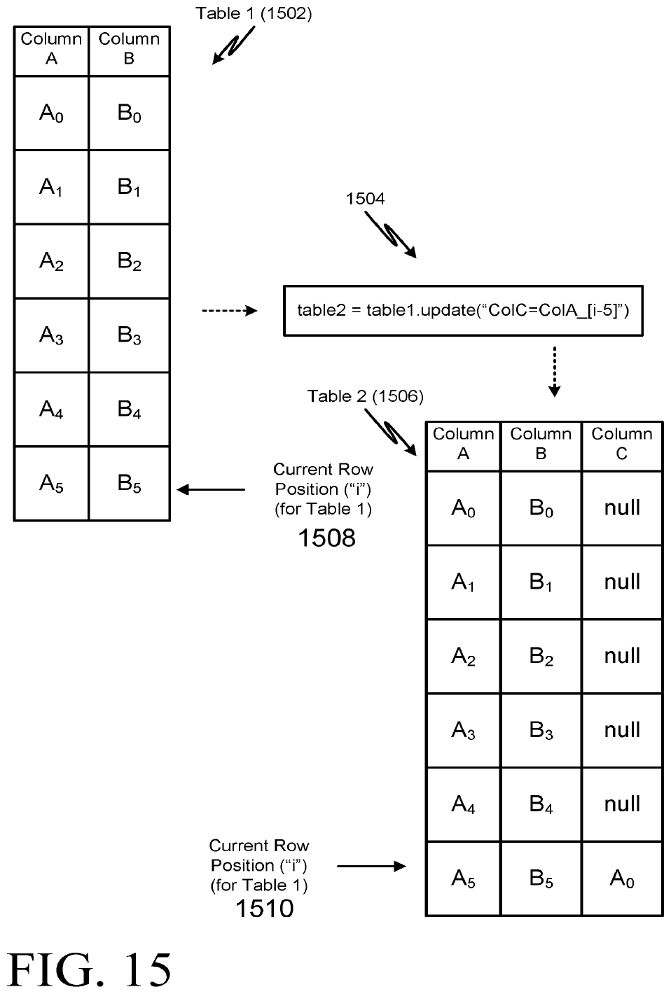

FIG. 15 is a diagram showing data objects in connection with relative offset processing in accordance with some implementations. In particular, a first table “Table 1” 1502 is provided as input to query language code 1504 including an “update” command having “i” in the argument string for the command.

In operation, the query language code is parsed into a parsed query language structure (e.g., an abstract syntax tree), which is used to generate computer programming language code (including code that corresponds to the arguments including “i”) that is then compiled and executed to perform the operation specified by the query language code. Following execution of the compiled computer programming language code, a new table 1506 is created as a result of the update operation. The new table 1506 including data retrieved using a relative offset (e.g., “i-5”), which in this case results in Column C having a value from Column A offset by 5 index values from the current row position represented by the “i” query language construct. The underscore query language construct following the ColA reference is interpreted by the computer data system as referring to the entire Column A as an array. It will be appreciated that an offset could be negative or positive. Also, it is important to note that for a table that is dynamically updating, a result of the update operation including the current row position reference and/or offset will be updated as well. For example, if Table 1 (1502) is updated to include a newly added row at the end of the table the current row position for evaluating a formula using “i” would be 6, Table 2 (1506) created by the update operation including “i-5” will be updated as well and will include a new row comprising A6, B6 and A1.

As mentioned above, the “ColA_” query language construct indicates that ColA should not be interpreted as the value of ColA in the current row, but rather as the entire column treated as an array or vector, indexed by position. The result of Table 2 1506 can include all the rows of Table 1 1502. For columns where A[i-5] is undefined, the Column C value is null. Some implementations can include an ability to process values for which an index is undefined by defining a special null value that allows operations to be computed without generating an exception or error.

Some implementations can include query language program constructs for relative indexing such as t2=t1.update(“B=A_[i-5]”), and/or absolute indexing such as t2=t1.update(“B=A_[4]”). Some implementations can also include a query language construct to access an array with a function such as t2=t1.update(“B=head (A_,6)”), which return the first 6 values of column “A” as an array or vector. It will be appreciated that array and vector operations are not limited to absolute and/or relative indexing, but that all available array language construct or operations may be made available including passing by reference, passing by value, slicing, element access, apply, length retrieval, element retrieval, etc. are made available.

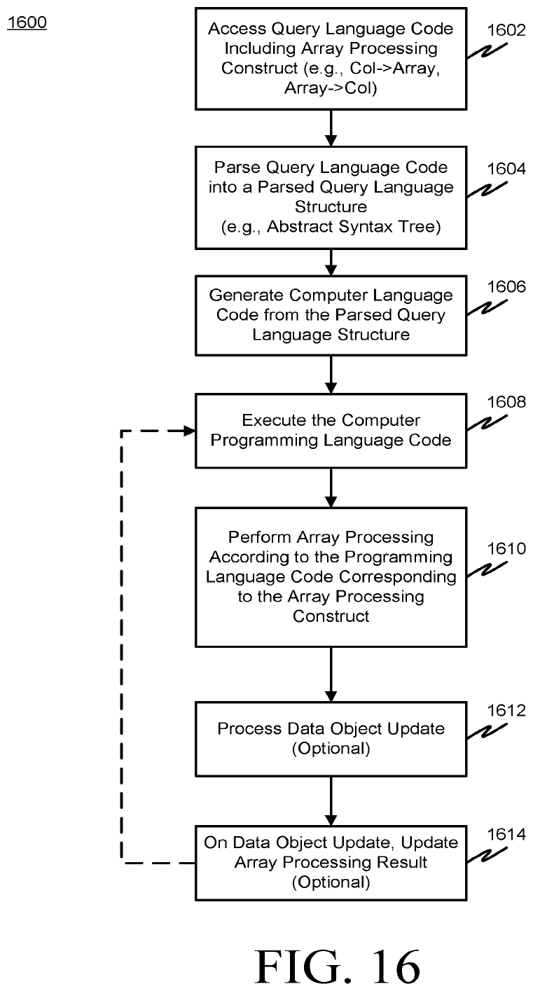

FIG. 16 is a flowchart of an example process 1600 for column-to-array transform processing in accordance with some implementations. Processing begins at 1602, where query language code is accessed. The query language code including an array operation construct (e.g., a “by” operation, an “ungroup” operation or the like). Processing continues to 1604.

At 1604, the data system query language code is parsed into a parsed query language structure (e.g., a syntax tree, an abstract syntax tree, or the like). Processing continues to 1606.

At 1606, computer programming language code is generated from the parsed query language structure. Computer programming language functions are generated for the array processing code constructs from the query language code. The generated computer programming language code can be compiled. Processing continues to 1608.

At 1608, the compiled computer programming language code is executed on one or more hardware processors. Processing continues to 1610.

At 1610, when the executable code corresponding to the array processing construct is executed, the programming language code performs the array processing operation. Processing continues to 1612.

At 1612, an update for the data object is optionally processed. An update can include one or more of add, modify, delete or reindex messages being processed for the data object. Processing continues to 1614.

At 1614, when a data object update is determined, an array operation processing result is optionally updated. Processing returns to 1608, where the programming language code continues to execute.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC), a field programmable gate array (FPGA), a graphics processing unit (GPU) or the like. The instructions can be compiled from source code instructions provided in accordance with a programming language such as Java, C, C++, C#.net, assembly or the like. The instructions can also comprise code and data objects provided in accordance with, for example, the Visual Basic™ language, a specialized database query language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, GP, GPU, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for providing a current row position query language construct and array processing (e.g., column-to-array transforms and array-to-column transforms) query language constructs and associated processing.

application Ser. No. 15/154,974, entitled “DATA PARTITIONING AND ORDERING” (Attorney Docket No. W1.1-10057) and filed in the United States Patent and Trademark Office on May 14, 2016, is hereby incorporated by reference herein in its entirety as if fully set forth herein.

application Ser. No. 15/154,975, entitled “COMPUTER DATA SYSTEM DATA SOURCE REFRESHING USING AN UPDATE PROPAGATION GRAPH” (Attorney Docket No. W1.4-10058) and filed in the United States Patent and Trademark Office on May 14, 2016, is hereby incorporated by reference herein in its entirety as if fully set forth herein.

application Ser. No. 15/154,979, entitled “COMPUTER DATA SYSTEM POSITION-INDEX MAPPING” (Attorney Docket No. W1.5-10083) and filed in the United States Patent and Trademark Office on May 14, 2016, is hereby incorporated by reference herein in its entirety as if fully set forth herein.

application Ser. No. 15/154,980, entitled “SYSTEM PERFORMANCE LOGGING OF COMPLEX REMOTE QUERY PROCESSOR QUERY OPERATIONS” (Attorney Docket No. W1.6-10074) and filed in the United States Patent and Trademark Office on May 14, 2016, is hereby incorporated by reference herein in its entirety as if fully set forth herein.

application Ser. No. 15/154,983, entitled “DISTRIBUTED AND OPTIMIZED GARBAGE COLLECTION OF REMOTE AND EXPORTED TABLE HANDLE LINKS TO UPDATE PROPAGATION GRAPH NODES” (Attorney Docket No. W1.8-10085) and filed in the United States Patent and Trademark Office on May 14, 2016, is hereby incorporated by reference herein in its entirety as if fully set forth herein.

application Ser. No. 15/154,984, entitled “COMPUTER DATA SYSTEM CURRENT ROW POSITION QUERY LANGUAGE CONSTRUCT AND ARRAY PROCESSING QUERY LANGUAGE CONSTRUCTS” (Attorney Docket No. W2.1-10060) and filed in the United States Patent and Trademark Office on May 14, 2016, is hereby incorporated by reference herein in its entirety as if fully set forth herein.

application Ser. No. 15/154,985, entitled “PARSING AND COMPILING DATA SYSTEM QUERIES” (Attorney Docket No. W2.2-10062) and filed in the United States Patent and Trademark Office on May 14, 2016, is hereby incorporated by reference herein in its entirety as if fully set forth herein.

application Ser. No. 15/154,987, entitled “DYNAMIC FILTER PROCESSING” (Attorney Docket No. W2.4-10075) and filed in the United States Patent and Trademark Office on May 14, 2016, is hereby incorporated by reference herein in its entirety as if fully set forth herein.

application Ser. No. 15/154,988, entitled “DYNAMIC JOIN PROCESSING USING REAL-TIME MERGED NOTIFICATION LISTENER” (Attorney Docket No. W2.6-10076) and filed in the United States Patent and Trademark Office on May 14, 2016, is hereby incorporated by reference herein in its entirety as if fully set forth herein.

application Ser. No. 15/154,990, entitled “DYNAMIC TABLE INDEX MAPPING” (Attorney Docket No. W2.7-10077) and filed in the United States Patent and Trademark Office on May 14, 2016, is hereby incorporated by reference herein in its entirety as if fully set forth herein.

application Ser. No. 15/154,991, entitled “QUERY TASK PROCESSING BASED ON MEMORY ALLOCATION AND PERFORMANCE CRITERIA” (Attorney Docket No. W2.8-10094) and filed in the United States Patent and Trademark Office on May 14, 2016, is hereby incorporated by reference herein in its entirety as if fully set forth herein.

application Ser. No. 15/154,993, entitled “A MEMORY-EFFICIENT COMPUTER SYSTEM FOR DYNAMIC UPDATING OF JOIN PROCESSING” (Attorney Docket No. W2.9-10107) and filed in the United States Patent and Trademark Office on May 14, 2016, is hereby incorporated by reference herein in its entirety as if fully set forth herein.

application Ser. No. 15/154,995, entitled “QUERY DISPATCH AND EXECUTION ARCHITECTURE” (Attorney Docket No. W3.1-10061) and filed in the United States Patent and Trademark Office on May 14, 2016, is hereby incorporated by reference herein in its entirety as if fully set forth herein.

application Ser. No. 15/154,996, entitled “COMPUTER DATA DISTRIBUTION ARCHITECTURE” (Attorney Docket No. W3.2-10087) and filed in the United States Patent and Trademark Office on May 14, 2016, is hereby incorporated by reference herein in its entirety as if fully set forth herein.

application Ser. No. 15/154,997, entitled “DYNAMIC UPDATING OF QUERY RESULT DISPLAYS” (Attorney Docket No. W3.3-10059) and filed in the United States Patent and Trademark Office on May 14, 2016, is hereby incorporated by reference herein in its entirety as if fully set forth herein.

application Ser. No. 15/154,998, entitled “DYNAMIC CODE LOADING” (Attorney Docket No. W3.4-10065) and filed in the United States Patent and Trademark Office on May 14, 2016, is hereby incorporated by reference herein in its entirety as if fully set forth herein.

application Ser. No. 15/154,999, entitled “IMPORTATION, PRESENTATION, AND PERSISTENT STORAGE OF DATA” (Attorney Docket No. W3.5-10088) and filed in the United States Patent and Trademark Office on May 14, 2016, is hereby incorporated by reference herein in its entirety as if fully set forth herein.

application Ser. No. 15/155,001, entitled “COMPUTER DATA DISTRIBUTION ARCHITECTURE” (Attorney Docket No. W3.7-10079) and filed in the United States Patent and Trademark Office on May 14, 2016, is hereby incorporated by reference herein in its entirety as if fully set forth herein.

application Ser. No. 15/155,005, entitled “PERSISTENT QUERY DISPATCH AND EXECUTION ARCHITECTURE” (Attorney Docket No. W4.2-10089) and filed in the United States Patent and Trademark Office on May 14, 2016, is hereby incorporated by reference herein in its entirety as if fully set forth herein.

application Ser. No. 15/155,006, entitled “SINGLE INPUT GRAPHICAL USER INTERFACE CONTROL ELEMENT AND METHOD” (Attorney Docket No. W4.3-10063) and filed in the United States Patent and Trademark Office on May 14, 2016, is hereby incorporated by reference herein in its entirety as if fully set forth herein.

application Ser. No. 15/155,007, entitled “GRAPHICAL USER INTERFACE DISPLAY EFFECTS FOR A COMPUTER DISPLAY SCREEN” (Attorney Docket No. W4.4-10090) and filed in the United States Patent and Trademark Office on May 14, 2016, is hereby incorporated by reference herein in its entirety as if fully set forth herein.

application Ser. No. 15/155,009, entitled “COMPUTER ASSISTED COMPLETION OF HYPERLINK COMMAND SEGMENTS” (Attorney Docket No. W4.5-10091) and filed in the United States Patent and Trademark Office on May 14, 2016, is hereby incorporated by reference herein in its entirety as if fully set forth herein.

application Ser. No. 15/155,010, entitled “HISTORICAL DATA REPLAY UTILIZING A COMPUTER SYSTEM” (Attorney Docket No. W5.1-10080) and filed in the United States Patent and Trademark Office on May 14, 2016, is hereby incorporated by reference herein in its entirety as if fully set forth herein.

application Ser. No. 15/155,011, entitled “DATA STORE ACCESS PERMISSION SYSTEM WITH INTERLEAVED APPLICATION OF DEFERRED ACCESS CONTROL FILTERS” (Attorney Docket No. W6.1-10081) and filed in the United States Patent and Trademark Office on May 14, 2016, is hereby incorporated by reference herein in its entirety as if fully set forth herein.

application Ser. No. 15/155,012, entitled “REMOTE DATA OBJECT PUBLISHING/SUBSCRIBING SYSTEM HAVING A MULTICAST KEY-VALUE PROTOCOL” (Attorney Docket No. W7.2-10064) and filed in the United States Patent and Trademark Office on May 14, 2016, is hereby incorporated by reference herein in its entirety as if fully set forth herein

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

1-20. (canceled)

21. A system for improving the functionality of computer data system query language code execution via compilation of query language constructs, the system comprising:
one or more hardware processors;
an electronic computer readable data storage device coupled to the one or more hardware processors, the electronic computer readable data storage device having stored thereon software instructions that, when executed by the one or more hardware processors, cause the one or more hardware processors to perform operations, thereby improving the functionality of computer data system query language code execution, the operations including:
accessing, at the one or more hardware processors, computer data system query language code stored in the electronic computer readable data storage device, the computer data system query language code including a current row value and a current data storage location value associated with a data object, wherein the current row value and the current data storage location value are constructs of a computer data system query language;
parsing, at the one or more hardware processors, the computer data system query language code into a parsed query language structure;
generating, at the one or more hardware processors, computer programming language code based on the parsed query language structure, the computer programming language code including computer programming language functions that are mapped to usages of the current row value and the current data storage location value, wherein the generated computer programming language code and the computer programming language functions are compiled;
executing, at the one or more hardware processors, the compiled computer programming language code;
determining, at the one or more hardware processors, based on execution of the compiled computer programming language code, a return data storage location value from the computer programming language functions corresponding to the current data storage location value, the return data storage location value representing a current data storage location of the data object corresponding to a query language construct at a time of execution of the compiled computer programming language code;
when one or more data sources that the data object depends on are updated, subsequently executing, at the one or more hardware processors, the compiled computer programming language code, including a portion of computer programming language code corresponding to the current data storage location, wherein the updating includes one or more of adding, modifying, deleting, or re-indexing the one or more data sources that the data object depends on; and
determining, at the one or more hardware processors, based on the subsequent execution of the compiled computer programming language code, a new return data storage location value from the computer programming language functions corresponding to the current data storage location value, the new return data storage location value representing an updated current data storage location of the data object corresponding to another query language construct at a subsequent time of execution of the compiled computer programming language code.

22. The system of claim 21, wherein the computer data system query language code includes a vector access query language construct configured to permit access to a vector representing an entire column of data values.

23. The system of claim 22, wherein the access includes one or more of absolute indexing and relative indexing.

24. The system of claim 22, wherein the vector access query language construct includes one or more of passing by reference, passing by value, slicing, length retrieval or element retrieval.

25. The system of claim 21, wherein the current row value of the data object is updated once the data sources providing data for the data object have been updated.

26. The system of claim 21, wherein the executing and determining are performed as part of a real time data system query.

27. The system of claim 21, wherein the operations further include mapping the current row value to the current data storage location value within a data source providing data for the data object.

28. The system of claim 21, wherein the computer data system query language code includes code retrieving data from one or more data object positions other than the current row value in order to compute a time series operation.

29. A system for improving the functionality of computer data system query language code, the system comprising:
one or more hardware processors;
an electronic computer readable data storage device coupled to the one or more hardware processors, the electronic computer readable data storage device having stored thereon software instructions that, when executed by the one or more hardware processors, cause the one or more hardware processors to perform operations, thereby improving the functionality of computer data system query language code, the operations including:
accessing, at the one or more hardware processors, computer data system query language code stored in the electronic computer readable data storage device, the computer data system query language code including an array processing query language construct including at least a portion of data within a data object as a parameter;
parsing, at the one or more hardware processors, the computer data system query language code into a parsed query language structure;
generating, at the one or more hardware processors, computer programming language code based on the parsed query language structure, the computer programming language code including a portion of computer programming language code corresponding to the array processing query language construct associated with the data object;
executing, at the one or more hardware processors, the computer programming language code, including the portion of computer programming language code corresponding to the array processing query language construct associated with the data object;
determining, at the one or more hardware processors, based on execution of the computer programming language code, a return value from the portion of computer programming language code corresponding to the array processing query language construct associated with the data object, the return value including transformed data from the data object;
when one or more data sources that the data object depends on are updated, subsequently executing, at the one or more hardware processors, the computer programming language code, including the portion of computer programming language code corresponding to the array processing query language construct associated with the data object; and
determining, at the one or more hardware processors, based on the subsequent execution of the computer programming language code, a new return value from the portion of computer programming language code corresponding to the array processing query construct associated with the data object, the new return value including updated transformed data from the data object at a subsequent time of execution of the computer programming language code.

30. The system of claim 29, wherein the array processing query language construct includes a column-to-array query language construct and the transformed data includes array data transformed from column data.

31. The system of claim 29, wherein the array processing query language construct includes an array-to-column query language construct and the transformed data includes column data transformed from array data.

32. The system of claim 30, wherein the operations further include performing a vector operation on the array data.

33. The system of claim 30, wherein the computer data system query language code includes a vector access query language construct configured to permit access to a vector formed by a column-to-array operation based on the column-to-array query language construct.

34. The system of claim 33, wherein the access includes one or more of absolute indexing and relative indexing.

35. The system of claim 29, wherein the executing and determining are performed as part of a real time data system query.

36. The system of claim 33, wherein the vector access query language construct includes one or more of passing by reference, passing by value, slicing, length retrieval or element retrieval.

37. A nontransitory computer readable medium having stored thereon software instructions that, when executed by one or more hardware processors, cause the one or more hardware processors to perform operations, thereby improving the functionality of computer data system query language code execution, the operations including:
accessing, at the one or more hardware processors,
computer data system query language code stored in the electronic computer readable data storage device, the computer data system query language code including a current row value and a current data storage location value associated with a data object, wherein the current row value and the current data storage location value are constructs of a computer data system query language;
parsing, at the one or more hardware processors, the computer data system query language code into a parsed query language structure;
generating, at the one or more hardware processors, computer programming language code based on the parsed query language structure, the computer programming language code including computer programming language functions that are mapped to usages of the current row value and the current data storage location value, wherein the generated computer programming language code and the computer programming language functions are processed;
executing, at the one or more hardware processors, the processed computer programming language code;
determining, at the one or more hardware processors, based on execution of the processed computer programming language code, a return index value from the computer programming language functions corresponding to the current row value, the return index value representing a current data storage location of the data object corresponding to a query language construct at a time of execution of the processed computer programming language code;
when one or more data sources that the data object depends on are updated, subsequently executing, at the one or more hardware processors, the processed computer programming language code, including a portion of computer programming language code corresponding to the current row value, wherein the updating includes one or more of adding, modifying, deleting, or re-indexing the one or more data sources that the data object depends on; and
determining, at the one or more hardware processors, based on the subsequent execution of the processed computer programming language code, a new return index value from the computer programming language functions corresponding to the current row value, the new return index value representing an updated current data storage location of the data object corresponding to another query language construct at a subsequent time of execution of the processed computer programming language code.

38. The nontransitory computer readable medium of claim 37, wherein the computer data system query language code includes a vector access query language construct configured to permit access to a vector representing an entire column of data values.

39. The nontransitory computer readable medium of claim 37, wherein the current row value of the data object is updated once the data sources providing data for the data object have been updated.

40. The nontransitory computer readable medium of claim 37, wherein the computer data system query language code includes code retrieving data from one or more data object positions other than the current row value in order to compute a time series operation.
